(19) United States
(12) Patent Application Publication
(10) Pub. No.: US 2007/0283444 A1
(43) Pub. Date: Dec. 6, 2007

(54) Apparatus And System For Preventing Virus

(75) Inventor: Keon Jang, Seoul (KR)

Correspondence Address: John W. Renner;Renner, Otto, Boisselle & Sklar, 1621 Euclid Avenue, 19th Floor, Cleveland, OH, 44116, US

(73) Assignee: BIZET INC., Seongdong-gu, Seoul (KR)

(21) Appl. No.: 11/667,028

(22) PCT Filed: Nov. 8, 2005
(86) PCT No.: PCT/KR05/03769

§ 371 Date: May 3, 2007

(30) Foreign Application Priority Data
Nov. 8, 2004 (KR) 10-2004-0090322

(51) Int. Cl. G06F 12/16

(52) U.S. Cl. 726/26

(57) ABSTRACT

A mobile virus prevention apparatus is provided. The mobile virus prevention apparatus can execute a vaccine program and be detachably mounted on a host connected to a network. The apparatus includes a first storage area for storing the vaccine program, the vaccine program having a binary format; and a second storage area for sending the vaccine program to the host when the apparatus is connected to the host, and storing an automatic execution file for automatically executing the sent vaccine program, the second storage area being set as a read only area, wherein the vaccine program sends the binary vaccine program to the host when the apparatus is connected to the host, and the sent vaccine program is recomposed as a file format and installed in the host. With the mobile virus prevention apparatus, it is possible to execute a vaccine program for virus prevention independently of an operating system and to install the vaccine program with minimized virus effects.

### TECHNICAL FIELD

The present invention relates to an apparatus for preventing virus that is based on a mobile storage device, and more particularly, to a mobile virus prevention apparatus that automatically loads a binary vaccine program to a host such as a computer and allows the host to recompose the binary vaccine program as a file and to install the vaccine program file when the virus prevention apparatus is connected to the host through a mobile storage device that is easily detachably mounted to the host.

### BACKGROUND ART

With the development of Internet, computer viruses that may adversely affect an operating system and application programs installed in the operating system have been widespread over networks. The computer viruses attack vulnerability of the operating system or the application programs, such that the computer abnormally operates or does not work and personal information of a computer user is exposed to others. A number of domestic and foreign companies are developing various vaccine programs. Most of the vaccine programs are sold to users through optical recording media or downloaded via the Internet.

FIG. 1 is a conceptual diagram illustrating a conventional installation and use of a vaccine program.

Referring to FIG. 1, a vaccine program stored in an optical recording medium 1 is copied into a hard disc drive 11 of a computer 10 and installed in the hard disc drive 11. In this case, the vaccine program can be installed in the hard disc drive 11 when the computer 10 is enabled, i.e., an operating system installed in the computer runs. The vaccine program is configured to have a monitoring program residing in a memory (e.g., RAM) 12 of the computer 10 to monitor the computer 10 in real time.

FIG. 2 is a flowchart illustrating a process of installing and using a vaccine program in FIG. 1.

The computer 10 is first booted by a user (S10). When the booting process of the computer 10 is completed, the computer 10 recognizes an AT attachment (ATA) devices (e.g., a hard disc drive, a CD ROM, et.) by a pre-installed operating system (e.g., Windows 98, Windows 2000 or Windows XP) (S11). An optical recording medium (e.g., CD ROM) is inserted into the computer 10 by the user and a vaccine program stored in the optical recording medium is copied into the hard disc drive 11 (S12) through the recognized ATA devices. The hard disc drive 11 then installs the copied vaccine program under the environment of the operating system (OS) (S13). Then, the installed vaccine program installs a monitoring program in the memory (RAM) 12 (S14) to monitor the computer 10 in real time (S15). If the computer is already infected by viruses before the vaccine program is installed in the computer 10 by the user, the vaccine program is also infected simultaneously with being copied into the computer 10. This is because the vaccine program is installed and operated in an environment provided by the operating system (OS), which is pre-installed in the computer 10. That is, if the operating system (OS) is infected by the viruses, the vaccine program may be not normally installed since the vaccine program itself is infected when being copied from the optical recording medium 1 to the hard disc driver 11. Further, when the user attempts to install a plurality of vaccine programs in the computer 10, monitoring programs for the respective vaccine programs may collide with one another since the vaccine program causes the monitoring program to automatically reside in the memory 12 after the computer 10 is booted. That is, when monitoring programs are automatically loaded in a RAM residence area of the memory 12, some one of the vaccine programs may not work.

This is because conventional vaccine programs operate depending on an operating system (OS) installed in the computer 10, and are run in a RAM by the operating system when the computer is booted. If a vaccine program of a file format is copied into the hard disc drive 11 while a virus-infected operating system (OS) is operating, the vaccine program may be also infected and difficult to be installed.

While companies having a number of computers connected to a network have a firewall installed to block virus intrusion from the Internet, viruses propagated through users floppy disks, USB drives and the like are difficult to be prevented by a network's virus prevention system.

### DISCLOSURE OF INVENTION

Technical Problem

The present invention has been made to solve the aforementioned problems associated with the prior art. It is an object of the present invention to provide a virus prevention apparatus capable of executing a vaccine program for preventing viruses independently of an operating system and minimizing the effect by the viruses upon installation of the vaccine program.

It is another object of the present invention to provide a virus prevention apparatus capable of providing a binary virus vaccine to a host such as a computer through an external storage medium such as a USB drive so that the host recomposes the binary virus vaccine as a file and installs the virus program file, thereby reducing the effect by the viruses and safely protecting companies' network environments from viruses.

Additional advantages, objects, and features of the invention will be set forth in part in the description which follows and in part will become apparent to those having ordinary skill in the art upon examination of the following or may be learned from practice of the invention.

Technical Solution

According to an aspect of the present invention, there is provided a virus prevention apparatus that can execute a vaccine program and be detachably mounted on a host connected to a network, the apparatus comprising: a first storage area for storing the vaccine program, the vaccine program having a binary format; and a second storage area for sending the vaccine program to the host when the apparatus is connected to the host, and having an automatic execution file for automatically executing the sent vaccine program, the second storage area being set as a read only area, wherein the vaccine program sends the binary vaccine program to the host when the apparatus is connected to the host, and the sent vaccine program is recomposed as a file format and installed in the host.

Preferably, the second storage area stores a mount program for mounting the second storage area as a virtual CD ROM on the host when the apparatus is connected to the host.

Preferably, the vaccine program comprises at least one file that is automatically executed when the apparatus is connected to the host, and the execution file enables the vaccine program to be installed in the host and then updated over a network connected to the host.

Preferably, the vaccine program is compressed and stored in the first storage area.

Preferably, the execution file has a function of decompressing the compressed vaccine program and transmitting it to the host.

Preferably, the vaccine program stored in the first storage area comprises a pattern portion storing virus pattern data; and an engine portion performing virus prevention on the host referring to the pattern data after the vaccine program is installed in the host.

Preferably, the vaccine program updates pattern data pre-stored in the first storage area with the pattern data updated over the network.

Preferably, the engine portion comprises a program execution file portion for executing the vaccine program; and a dynamic linking library (DLL) portion executed by the program execution file.

Preferably, the apparatus is connected to the host via a universal serial bus (USB).

Preferably, the apparatus further comprises a third storage area for storing files requested by the host to be stored.

Preferably, one of the first storage area, the second storage area, and the third storage area stores information inherent in the mobile virus prevention apparatus, and the apparatus uses the inherent information to log in the host.

Preferably, the inherent information comprises a serial number of the mobile virus prevention apparatus, and license information.

Preferably, the mobile virus prevention apparatus performs update over a network connected to the host based on the serial number and the license information.

Preferably, the host is one of a desk top computer, a notebook computer and a personal digital assistant (PDA).

According to another aspect of the present invention, there is provided a mobile virus prevention apparatus comprising: a data arrangement table; and a vaccine storage area for storing a vaccine program as a binary file according to the data arrangement table, wherein the vaccine program is read in an off-set way according to a stored order and size and is provided to a host.

Preferably, the vaccine storage area stores at least one execution file that is automatically run when the apparatus is connected to the host, and the execution file enables the vaccine program to be installed in the host and then updated over a network connected to the host.

Preferably, the vaccine program is compressed and stored in the vaccine storage area.

Preferably, the apparatus further comprises a data storage area for storing files requested by the host to be stored.

Preferably, the apparatus is connected to the host via a universal serial bus (USB).

According to still another aspect of the present invention, there is provided a virus prevention system using a mobile virus prevention apparatus, the system comprising: a mobile storage medium detachably mounted on a computer, wherein when the mobile storage medium is mounted on the computer, the mobile storage medium accesses the computer based on inherent information, and automatically sends a pre-stored virus prevention program to the computer and installs the virus prevention program in the computer; and a server receiving the inherent information from the computer and providing the virus prevention program to the host based on the received inherent information.

Preferably, the inherent information comprises a serial number of the mobile storage medium, and license information for a virus program stored in the mobile storage medium.

According to still another aspect of the present invention, there is provided an external computer-readable recording medium having a program stored thereon, the program including a function of providing an instruction for executing a vaccine program in a computer and access information for the computer and accessing to the computer based on the access information; and a function of loading and unloading the vaccine program to and from the computer after the recording medium is connected to the computer, and wherein the vaccine program is loaded independently of an operating system installed in the computer.

Advantageous Effects

The mobile virus prevention apparatus as described above according to the present invention can execute a vaccine program for virus prevention independently of an operating system, and install the vaccine program with minimized virus effects. According to the present invention, it is possible to minimize virus intrusion into a network to which computers belong by minimizing virus intrusion into the computer. It is also possible to minimize virus infection upon data transmission between a computer and a mobile storage device by embedding a vaccine program in a mobile storage device that causes viruses to invade a network having a firewall.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a conceptual diagram illustrating conventional installation and use of a vaccine program;

FIG. 2 is a flowchart illustrating a process of installing and using a vaccine program in FIG. 1;

FIG. 3 illustrates an example of a dynamical execution technique of a virus vaccine, in which a connection relationship between a USB drive as a representative mobile storage device and a computer is conceptually described, according to an embodiment of the present invention;

FIG. 4 is a conceptual diagram illustrating a connection relationship between a USB drive and a virus vaccine update server according to an embodiment of the present invention;

FIG. 5 is a schematic diagram illustrating the internal structure of the USB drive shown in FIGS. 3 and 4;

FIG. 6 illustrates an example in which a vaccine program is stored in a binary area shown in FIG. 5;

FIG. 7 illustrates an example of the structure of a binary area of a USB drive; and

FIG. 8 is a conceptual diagram illustrating a process in which a USB drive is connected to a computer and a virus vaccine is run.

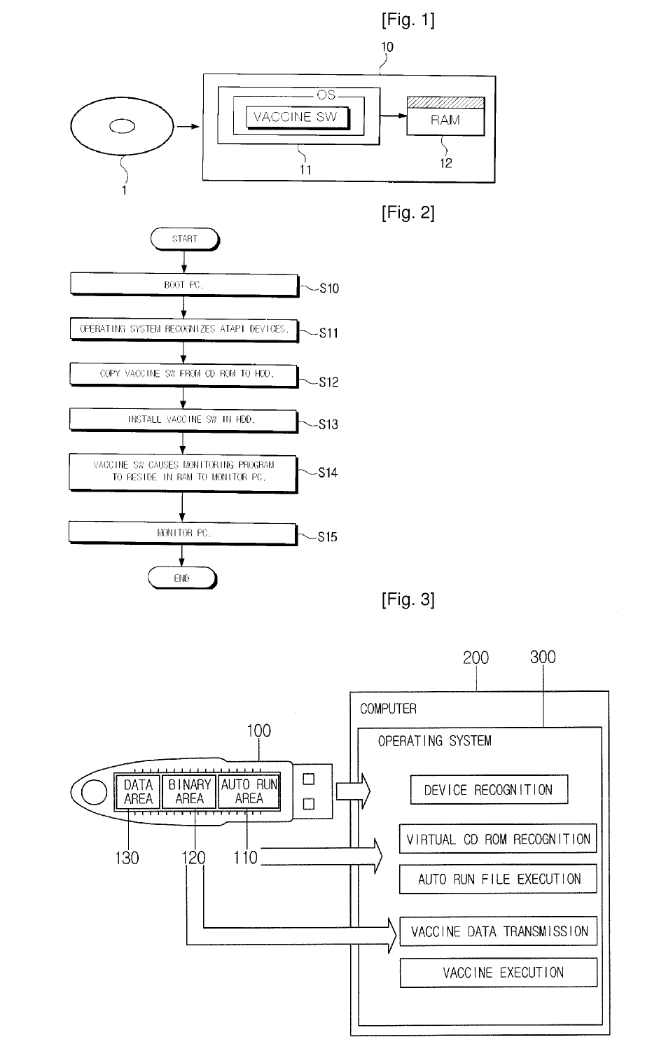

### MODE FOR THE INVENTION

Hereinafter, the present invention will be described in detail with reference to the accompanying drawings.

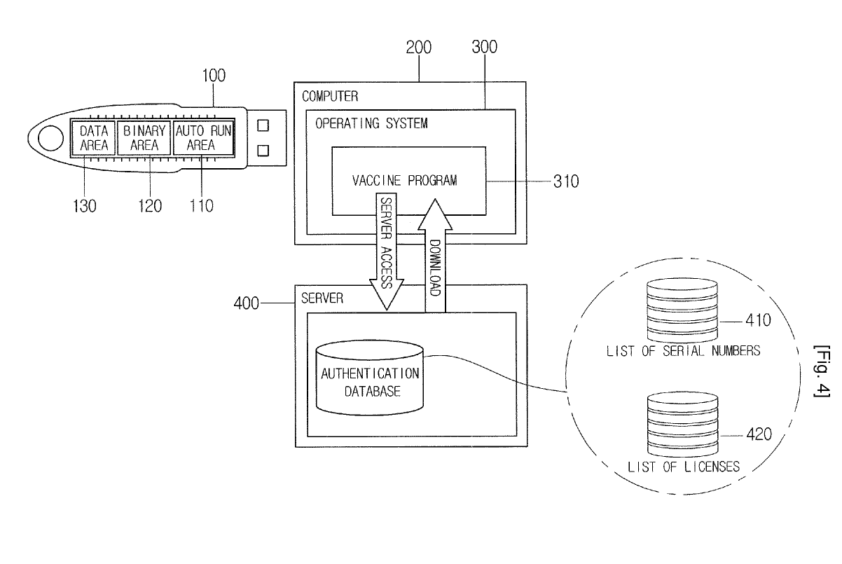

FIG. 3 illustrates an example of a dynamical execution technique of a virus vaccine, in which a connection relationship between a USB drive as a representative mobile storage device and a computer is conceptually described, according to an embodiment of the present invention.

Referring to FIG. 3, a USB drive 100 is connected to a computer 200 by a user, and a binary vaccine program in the USB drive 100 is sent to the computer 200 and executed to protect the computer 200 from viruses.

A mobile storage device for carrying the vaccine program may be a medium using various storage ways such as an AT attachment (ATA), IEEE1394 and the like other than the USB drive 100. In this example, the mobile storage device is a USB type mobile storage device, which is currently widely used as a mobile storage device and is easily connected to a computer. A vaccine program is stored in a binary area of the USB drive 100 and is composed as a binary data, unlike data stored as a file format in a typical optical recording medium. The vaccine program does not have a file format before being read and recomposed by the computer 200, which is described below. Accordingly, the vaccine program stored in the USB drive 100 is not infected by viruses when being sent to the computer 200 even though the computer 200 is already infected by the viruses.

When the USB drive 100 is connected to the computer 200, the USB drive 100 is recognized by an operating system 300 installed in the computer.

The USB drive 100 may enable the computer 200 to recognize the USB drive as a mobile disc or may be automatically run by setting an automatic execution area 110 of the USB drive 100 as a virtual CD ROM. The automatic execution area 110 includes a program for causing the computer 200 to recognize the automatic execution area 110 as a virtual CD ROM. The automatic execution area 110 is registered in the computer 200 as the virtual CD ROM by executing the program. Accordingly, the automatic execution area 110 recognized as the virtual CD ROM sends a vaccine program stored in the binary area 120 to the computer 200. The automatic execution area 110 stores an automatic execution program having a function of setting the automatic execution area 110 as the virtual CD ROM in the computer 200 when the USB drive 100 is connected to the computer 200, and a function of sending a binary vaccine program stored in the binary area 120 to the computer 200.

The binary area 120 comprises the binary vaccine program. The vaccine program is compressed and stored in the binary area 120. The compressed vaccine program is recomposed as a file format by the computer 200, which is described in detail below. A data area 130 is recognized as a mobile disc by the operating system 300 and file data is written to and read from the data area 130.

FIG. 4 conceptually illustrates a connection relationship between a USB drive and a virus vaccine update server according to an embodiment of the present invention.

Referring to FIG. 4, after a USB drive 100 is connected to a computer 200, a vaccine program in the USB drive 100 is send to and installed in the computer 200 by an automatic execution program, and the installed vaccine program accesses a vaccine program providing server 400 to update virus pattern and information. When the installed vaccine program connects to the server 400 to update the virus information, the vaccine program reads a serial number and license information from the automatic execution area 110 of the USB drive 100 and sends them to the server. The serial number and the license information are compared to a serial number list 410 and a license list 420 registered in the server 400. If they match each other, the server 400 gives authorization for vaccine program update so that the vaccine program logs in the server 400. When the vaccine program is logged in the server 400 based on the serial number list 410 and the license list 420 stored in the automatic execution area 110 of the USB drive 100, the server 400 updates the computer 200 with virus information and provides the virus information to the binary area 120 of the USB drive 100 to store it.

That is, the virus information is allowed to be updated by the server 400 only in case the USB drive 100 is registered in the server 400 by means of its serial number. And after authenticating the update authorization based on license information, the virus information can be updated through the server 400.

Accordingly, when the computer 200 connects to the server 400 over the network to update virus information, the USB drive 100 shown in FIG. 4 is used as a tool for authentication of the update authorization. For example, if a typical virus vaccine is sold with update authorization limited to one year, the serial number of the USB drive 100 should be input to the server 400, and use authorization can be checked by specifying use expiration date in license issued when the virus vaccine is sold. The information is checked based on read-only information in the automatic execution area 110, thereby preventing illegal copies or use authorization modification.

While the serial number and license information set in the USB drive 100 have been described as being stored in the auto run area 110, they may be stored in the binary area 120 or the data area 130.

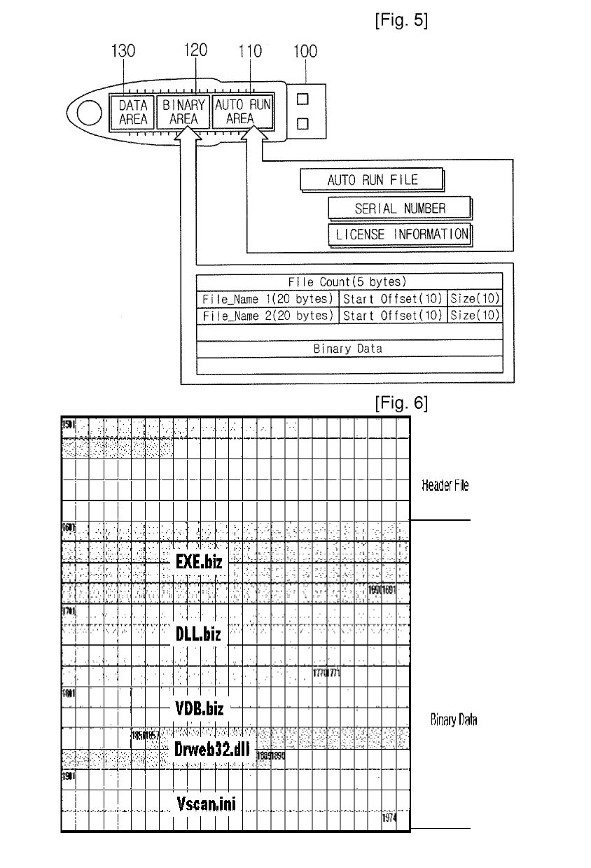

FIG. 5 is a schematic diagram illustrating the internal structure of the USB drive shown in FIGS. 3 and 4.

A USB drive 100 is connected to a computer 200 via a USB interface. An internal memory is a flash memory. The flash memory is divided into three areas, i.e., an automatic execution area 110, a binary area 120, and a data area 130.

The automatic execution area 110 includes an execution file for automatically transmitting a virus vaccine to the computer 200, and inherent information such as a serial number and license information needed to log in the virus vaccine update server 300. The inherent information first written to the area is not modified later. Thus, a serial number of the USB drive 100 and license information may be stored in the automatic execution area 110. The serial number is a serial number assigned to the USB drive upon manufacturing the USB drive, and the license information is license information for a virus vaccine stored in the USB drive. The serial number indicates information about memory capacity, manufacturing date, release region, and the like of the USB drive. The license information indicates authorization, features and the like for the virus vaccine stored in the USB drive. The serial number of the manufactured USB drive is pre-stored in the virus vaccine update server, and the license information is written to the virus vaccine update server when the USB drive first accesses the virus vaccine update server. The serial number is used to ascertain authorization to access the virus vaccine update server, and the license information is used to ascertain authorization to download updated virus information from the server. For example, when a USB drive having virus vaccine update authorization that is effective during one year accesses the server after one year elapses, use authorization expiration information is displayed. When the use authorization is updated through payment, the USB drive can download updated virus information from the server.

Virus vaccine data may be stored in the binary area 120 by a file map way or an offset way. The offset method as the most typical method will be described herein by way of example. As shown in FIG. 6, the binary area 120 allows for data recomposition through a header having the number of stored files (file count), a file name (File_Name), offset information (Start Offset), and size information (Size). That is, a file in a typical file system has an independent file format while data in the binary area 120 is composed of a sequence of 1s and 0s. The data in the binary area 120 is composed as a typical file format by determining start and end of a file, a file name, and a file size based on the header. The offset information is used to sequentially read and recompose the binary data according to the file names on a list in the header. With the offset information, the binary data is not written and read using a directly specified address and is recomposed as a file based on file size information written to the header. That is, in the file composing way using the offset information, if the first file is from address 0001 to address 0010, the second file is determined as having start address 0011.

Here, the vaccine program stored in the binary area 120 is preferably compressed and stored so that the size of the vaccine program is reduced. More preferably, the vaccine program can be decompressed by a self extracting way. The self extracting way was implemented by U.S. WinZip Computing, Inc (PO Box 540, Mansfield, Conn. 06268, USA). Since the self extracting way is currently widespread and used over the Internet, detailed description of the self extracting way will be omitted.

Meanwhile, the compressed vaccine program stored in the binary area 120 is not affected by viruses before the vaccine program is sent to the computer 200 and then decompressed. Since the sent binary vaccine program is a file of a format that cannot be directly executed by the operating system, the binary vaccine program is not infected even when there are viruses infecting the operating system. When the binary vaccine program is compressed, the binary area may further include a program for decompressing the binary vaccine program. The decompressing program may be automatically run when the USB drive 100 is connected to the computer 200. As described above, the automatic execution program stored in the automatic execution area 110 may further include a function of decompressing the binary vaccine program stored in the binary area 120. Accordingly, when the USB drive 100 is connected to the computer 200, the binary virus vaccine compressed by an automatic execution program and written to the automatic execution area 110 of the USB drive 100 is sent to a system and automatically decompressed.

The data area 130 is a data storage area for exchanging data with the computer 200. The data area 130 is available when the computer 200 logs in using user information stored in the automatic execution area 110. Preferably, the data area 130 has the same file system as the computer 200. Commonly, the computer 200 including an operating system of Windows series (Windows 98, Windows 2000, Windows XP, etc.) may have a file system such as FAT 16, FAT 32, or NTFS, the data area is preferably based on the FAT 16 or FAT 32 file system among the file systems, which is applied to a floppy disc or a USB storage medium.

FIG. 6 illustrates an example in which a vaccine program is stored in a binary area shown in FIG. 5.

Referring to FIG. 6, a vaccine program includes EXE.biz, DLL.biz, VDB.biz, Drweb32.dll, and vscan.ini. File names of these files are written to a header. While not shown in FIG. 6, the vaccine program includes the sizes of the files and offset values of the files. Substantial data of the files are stored in a binary format, and recomposed by the header after being sent to the computer 200.

The header file has information about a file name, a start address and a file size of each file. Each file specified by the header file may have a size that can be changed through update. When file information is changed through the update, the header file updates and stores the information about the start address and the file size of the changed file. Accordingly, the size of the header file storage area is kept as a fixed value and only the values stored in the header file are changed. Since the EXE.biz, DLL.biz, VDB.biz, Drweb32.dll, Vscan.ini and the like, which constitute the compressed and stored vaccine program, have a file size that can be changed through update, the size of the binary data storage area may be changed, and the changed information is written to the header file.

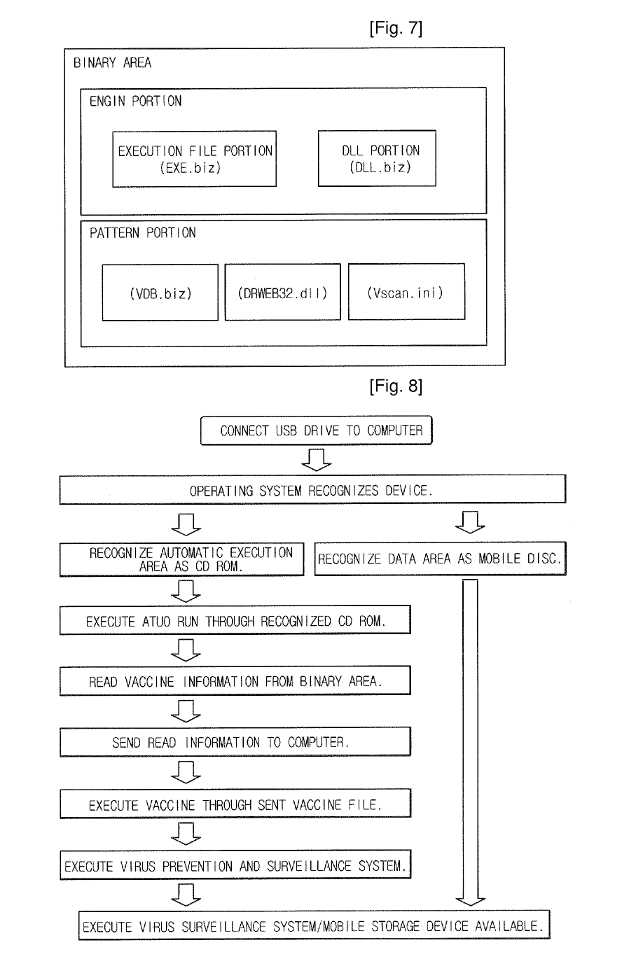

FIG. 7 illustrates an example of the structure of a binary area 120 of a USB drive 100.

In FIG. 7, a binary area 120 is divided into an engine portion and a pattern portion. The engine portion includes an execution program for executing a vaccine program, and the pattern portion includes virus pattern data. The engine portion is configured to quarantine viruses by referring to the pattern data. When the USB drive 100 is connected to a computer 200, the USB drive 100 connects to a virus update server providing virus pattern data via the computer 200 and receives necessary pattern data for update. Accordingly, the pattern portion storing the pattern data should be set as a writeable and readable area. Preferably, the engine portion may further include a dynamic linking library (DLL) portion. The DLL portion is a file or a group of files executed in association with the execution file portion. The DLL portion is not executed by itself but is executed in response to invoke from the execution file when the execution file is run. This allows a function of the engine portion having the execution file to be updated. The update of the engine portion is made in the same way as the pattern data update.

FIG. 8 is a conceptual diagram illustrating a process in which a USB drive 100 is connected to a computer 200 and a virus vaccine operates.

When the USB drive 100 is connected to the computer 200 by a user, the USB drive 100 is recognized by the operating system 300 installed in the computer 200. In this case, the automatic execution area 110 of the USB drive 100 is recognized as a CD ROM by the operating system 300, and an automatic execution file stored in the automatic execution area reads a compressed and stored virus vaccine from the binary area 120 of the USB drive 100. The read vaccine is sent to the computer 200 and is decompressed into a hard disc of the computer 200. The decompressed virus vaccine is automatically executed by the automatic execution program, such that a prevention system for the computer 200 to which the USB drive 100 is connected, as well as a virus prevention system for the USB drive 100, is run.

When the virus vaccine is being dynamically run by the automatic execution area 110 and the binary area 120, the data area 130 is recognized as a mobile disc by the operating system 300 such that file data in the data area 130 can be read or written.

### INDUSTRIAL APPLICABILITY

As described above, the mobile virus prevention apparatus of present invention can execute a vaccine program for virus prevention independently of an operating system, and install the vaccine program with minimized virus effects. According to the present invention, it is possible to minimize virus intrusion into a network to which computers belong by minimizing virus intrusion into the computer. It is also possible to minimize virus infection upon data transmission between a computer and a mobile storage device by embedding a vaccine program in a mobile storage device that causes viruses to invade a network having a firewall.

1. A virus prevention apparatus that can execute a vaccine program and be detachably mounted on a host connected to a network, the apparatus comprising:
a first storage area for storing the vaccine program, the vaccine program having a binary format; and
a second storage area for sending the vaccine program to the host when the apparatus is connected to the host, and having an automatic execution file for automatically executing the sent vaccine program, the second storage area being set as a read only area;
wherein the vaccine program sends the binary vaccine program to the host when the apparatus is connected to the host, and the sent vaccine program is recomposed as a file format and installed in the host.

2. The apparatus as claimed in claim 1, wherein the second storage area stores a mount program for mounting the second storage area as a virtual CD ROM on the host when the apparatus is connected to the host.

3. The apparatus as claimed in claim 1, wherein the vaccine program comprises at least one file that is automatically executed when the apparatus is connected to the host, and the execution file enables the vaccine program to be installed in the host and then updated over a network connected to the host.

4. The apparatus as claimed in claim 3, wherein the execution file has a function of decompressing the compressed vaccine program and transmitting the decompressed vaccine program to the host.

5. The apparatus as claimed in claim 1, wherein the vaccine program is compressed and stored in the first storage area.

6. The apparatus as claimed in claim 1, wherein the vaccine program stored in the first storage area comprises a pattern portion storing virus pattern data; and an engine portion performing virus prevention on the host referring to the pattern data after the vaccine program is installed in the host.

7. The apparatus as claimed in claim 6, wherein the vaccine program updates pattern data pre-stored in the first storage area with the pattern data updated over the network.

8. The apparatus as claimed in claim 6, wherein the engine portion comprises:
a program execution file portion for executing the vaccine program; and
a dynamic linking library (DLL) portion executed by the program execution file.

9. The apparatus as claimed in claim 1, wherein the apparatus is connected to the host via a universal serial bus (USB).

10. The apparatus as claimed in claim 1, further comprising a third storage area for storing files requested by the host to be stored.

11. The apparatus as claimed in claim 10, wherein one of the first storage area, the second storage area and the third storage area stores information inherent in the mobile virus prevention apparatus, and the apparatus uses the inherent information to log in the host.

12. The apparatus as claimed in claim 11, wherein the inherent information comprises a serial number of the mobile virus prevention apparatus and license information.

13. The apparatus as claimed in claim 12, wherein the mobile virus prevention apparatus performs update over a network connected to the host based on the serial number and the license information.

14. The apparatus as claimed in claim 1, wherein the host is one of a desk top computer, a notebook computer and a personal digital assistant (PDA).

15. A mobile virus prevention apparatus comprising:
a data arrangement table; and
a vaccine storage area for storing a vaccine program as a binary file according to the data arrangement table;
wherein the vaccine program is read in an off-set way according to stored order and size and is provided to a host.

16. The apparatus as claimed in claim 15, wherein the vaccine storage area stores at least one execution file that is automatically run when the apparatus is connected to the host, and the execution file enables the vaccine program to be installed in the host and then updated over a network connected to the host.

17. The apparatus as claimed in claim 15, wherein the vaccine program is compressed and stored in the vaccine storage area.

18. The apparatus as claimed in claim 15, further comprising a data storage area for storing files requested by the host to be stored.

19. The apparatus as claimed in claim 15, wherein the apparatus is connected to the host via a universal serial bus (USB).

20. A virus prevention system using a mobile virus prevention apparatus, the system comprising:
a mobile storage medium detachably mounted to a computer, wherein when the mobile storage medium is mounted to the computer, the mobile storage medium accesses the computer based on inherent information, and automatically sends a pre-stored virus prevention program to the computer and installs the virus prevention program in the computer; and
a server receiving the inherent information from the computer and providing the virus prevention program to the host based on the received inherent information.

21. The system as claimed in claim 20, wherein the inherent information comprises a serial number of the mobile storage medium, and license information for a virus program stored in the mobile storage medium.

22. An external computer-readable recording medium having a program stored thereon, the program including a function of providing an instruction for executing a vaccine program in a computer and access information for the computer and accessing to the computer based on the access information; and a function of loading and unloading the vaccine program to and from the computer after the recording medium is connected to the computer;
wherein the vaccine program is loaded independently of an operating system installed in the computer.
